(19) United States
(12) Patent Application Publication
(10) Pub. No.: US 2006/0038491 A1
(43) Pub. Date: Feb. 23, 2006

(54) Gas-discharge display apparatus

(75) Inventors: Kazuya Akiyama, Yamanashi-ken (JP); Yo Hibino, Yamanashi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Pioneer Corporation, Tokyo (JP)

(21) Appl. No.: 11/206,126

(22) Filed: Aug. 18, 2005

(30) Foreign Application Priority Data
Dec. 17, 2004 (JP) 2004-366626
Aug. 23, 2004 (JP) 2004-242504

(51) Int. Cl. H01J 17/49

(52) U.S. Cl. 313/582; 313/486; 313/487

(57) ABSTRACT

A discharge is initiated in a discharge space defined between the front glass substrate and the back glass substrate, whereby vacuum ultraviolet light is generated from a discharge gas filling the discharge space and excite phosphor layers. Each of the phosphor layers is formed of a firs phosphor having a resistance to an Xe resonance line, and absorbing the Xe resonance line and ultraviolet light in a longer wavelength range than the Xe resonance line and the Xe molecular beam but allowing the Xe molecular beam to pass through, and a second phosphor absorbing the Xe resonance line and the Xe molecular beam and generating ultraviolet light in a longer wavelength range than the Xe resonance line and the Xe molecular beam.

### BACKGROUND OF THE INVENTION

1. Field of the Invention

This invention relates to the structure of a phosphor layer provided in a gas-discharge display apparatus for generating visible light.

The present application claims priority from Japanese Applications No. 2004-242504 and No. 2004-366626, the disclosure of which are incorporated herein by reference.

2. Description of the Related Art

In a typical structure of a plasma display panel (hereinafter referred to as “PDP”) which is a type of gas-discharge display apparatus, a pair of opposing substrates are placed on both sides of a discharge space. Row electrode pairs, a dielectric layer covering the row electrode pairs, and a protective layer covering the dielectric layer is formed on the inner face of one of the substrates. Column electrodes, a column-electrode protective layer covering the column electrodes and red-, green- and blue-colored phosphor layers are formed on the inner face of the other substrate. The column electrode extends in a direction at right angles to the row electrode pairs and forms discharge cells in matrix form in positions corresponding to the intersections with the row electrode pairs within the discharge space. The red-, green- and blue-colored phosphor layers are individually formed on the column-electrode protective layer in each discharge cell.

The discharge space is filled with a discharge gas including xenon (Xe).

A PDP of such a structure produces an address discharge selectively between one row electrode in the row electrode pair and the column electrode. The address discharge results in the deposition of a wall charge on the portion of the dielectric layer facing the discharge cell. In each of the discharge cells having the deposition of wall charge (light-emitting cells), a sustaining discharge is caused between the row electrodes of the row electrode pair. Vacuum ultraviolet light produced from the xenon (Xe) included in the discharge gas by means of this sustaining discharge excites the phosphor layers to allow them to emit visible color light, thereby forming an image in accordance with an image signal.

The vacuum ultraviolet light generated from the xenon (Xe) in the discharge gas by means of the sustaining discharge includes a resonance line (147 nm), a molecular beam (172 nm) and the like.

The vacuum ultraviolet light has high energy. When the phosphor layer is irradiated for a long time with the high-energy vacuum ultraviolet light, deterioration over time such as that caused by brightness degradation occurs in the phosphor layer.

The deterioration over time noticeably occurs in the blue phosphor layer as a result of adding europium to barium, magnesium and aluminium oxides which are typically used for PDPs.

A conventional PDP proposed in order to prevent such deterioration of the phosphor layer includes a phosphor layer of a double-layer structure constituted of a first phosphor layer that is the top layer and converts the Xe resonance line (147 nm), the Xe molecular beam (172 nm) and the like included in the vacuum ultraviolet light into a radiant beam (250 nm to 400 nm) of longer wavelength than these, and a second phosphor layer that is the bottom layer and is excited by the longer-wavelength radiant beam (250 nm to 400 nm) to emit visible light.

A conventional PDP of the structure described above is disclosed in Japanese Patent Laid-open Publication 11-67103, for example.

The conventional PDP, however, has the problem of a high conversion loss and thus the incapacity to ensure sufficient light-emission intensity, because the emission of visible light for forming an image is achieved through the two stages of the excitation and light emission process in the double-layer structure phosphor layer.

### SUMMARY OF THE INVENTION

An object of the present invention is to solve the problem associated with conventional gas-discharge display apparatuses as described above.

To attain this object, a gas-discharge display apparatus according to the present invention has a pair of opposing substrates which are placed on either side of a discharge space and between which phosphor layers are provided and discharge producing members are provided for initiating a discharge within the discharge space, the discharge space being filled with a discharge gas that includes xenon and generates vacuum ultraviolet light including a xenon molecular beam and a xenon resonance line by means of the discharge initiated between the discharge producing members to allow the vacuum ultraviolet light to excite the phosphor layers for visible light emission. The gas-discharge display apparatus is characterized in that each of the phosphor layers includes a first phosphor that has a resistance to the xenon resonance line, absorbs the xenon resonance and ultraviolet light in a longer wavelength range than those in the xenon resonance line and the xenon molecular beam and allows the xenon molecular beam to pass through, and a second phosphor that absorbs the xenon resonance line and the xenon molecular beam and generates ultraviolet light in a longer wavelength range than those in the xenon resonance line and the xenon molecular beam.

In the best mode for carrying out the present invention, a PDP has a front glass substrate provided thereon with row electrode pairs and a back glass substrate placed opposite the front glass substrate and provided thereon with column electrodes. Discharge cells are formed in the respective areas in a discharge space between the opposing front and back substrates in correspondence with the opposing portions of the row electrode pairs between which a discharge is initiated. Phosphor layers are formed in the respective discharge cells. The discharge space is filled with a discharge gas including xenon. Each of the phosphor layers includes a first phosphor and a second phosphor. The first phosphor has a resistance to the xenon resonance line (147 nm), and absorbs the xenon resonance and ultraviolet light in a longer wavelength range (210 nm to 400 nm) than those in the xenon resonance line and a xenon molecular beam (172 nm) but allows the xenon molecular beam to pass through. The second phosphor absorbs the xenon resonance line and the xenon molecular beam and generates ultraviolet light in a longer wavelength range than those in the xenon resonance line and the xenon molecular beam.

In the PDP according to this best mode, when a discharge is produced between the opposing portions of the row electrode pair within each of the discharge cells in the discharge space, a xenon resonance line included in the vacuum ultraviolet light generated from the xenon in the discharge gas filling the discharge space is absorbed by the first phosphor out of the phosphor included in the phosphor layer, and excites the first phosphor to allow it to emit visible light.

The Xe molecular beam in the vacuum ultraviolet light having passed through the first phosphor does not contribute to the light emission from the first phosphor, and is absorbed by the second phosphor and converted into ultraviolet light in a longer wavelength range than those in the Xe resonance line and the Xe molecular beam.

The ultraviolet light generated from the second phosphor is absorbed by the first phosphor and excites the first phosphor to enable it to emit visible light.

At this point, the first phosphor has a high resistance to the Xe resonance line in the vacuum ultraviolet light. For this reason, deterioration over time such as that caused by brightness degradation occurs less.

In this manner, the gas-discharge display apparatus in the best mode has the high intensity required for generating an image because the phosphor layer has a high resistance to the Xe resonance line in vacuum ultraviolet light, and because in order to supplement the shortage in light-emission intensity caused by the fact that the Xe molecular beam does not allow the first phosphor to emit light, the second phosphor converts the Xe molecular beam which has passed through the first phosphor into long-wavelength ultraviolet light capable of allowing the first phosphor to emit visible light.

The gas-discharge display apparatus decreases the conversion loss as compared with that in the conventional gas-discharge display apparatuses. This is because the first phosphor emits visible light through excitation by the Xe resonance line, and the second phosphor contributes to light emission by converting the Xe molecular beam that has not contributed to light emission from the first phosphor into ultraviolet light.

These and other objects and features of the present invention will become more apparent from the following detailed description with reference to the accompanying drawings.

### BRIEF DESCRIPTION OF THE DRAWINGS

FIG. 1 is a sectional view illustrating a first embodiment of the present invention.

FIG. 2 is a graph showing the excitation characteristics of the first phosphor in the first embodiment.

FIG. 3 is a diagram illustrating the passage and absorption states of vacuum ultraviolet light in the first phosphor and the second phosphor in the first embodiment.

FIG. 4 is a sectional view illustrating a second embodiment according to the present invention.

FIG. 5 is a diagram illustrating the passage and absorption states of vacuum ultraviolet light in the first phosphor and the second phosphor in the second embodiment.

FIG. 6 is a sectional view illustrating a third embodiment according to the present invention.

### DETAILED DESCRIPTION OF THE PREFERRED EMBODIMENTS

### First Embodiment

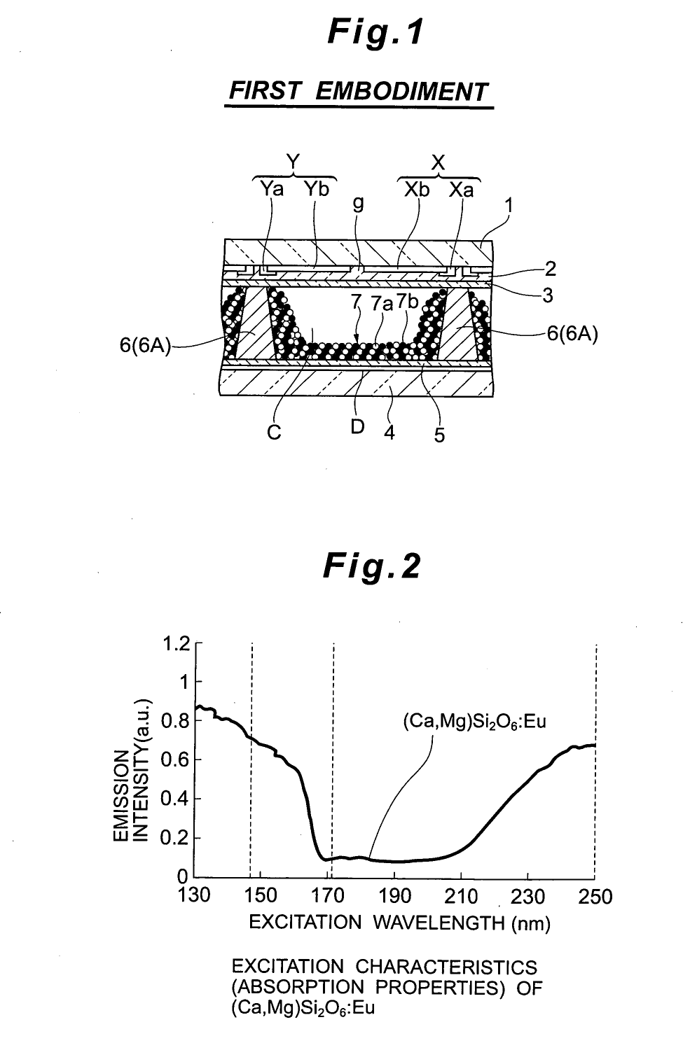

FIG. 1 is a sectional view illustrating the first embodiment when a gas-discharge display apparatus according to the present invention is used for a PDP.

FIG. 1 illustrates the section of the structure of an area of the PDP surrounding a discharge cell C taken in the column direction.

In FIG. 1, the PDP has row electrode pairs (X, Y) extending in the row direction (the vertical direction in relation to the drawing of FIG. 1) and regularly arranged in the column direction (the right-left direction in FIG. 1) on the inner face (i.e. the face facing toward the back of the PDP) of a front glass substrate 1 serving as the display surface.

Row electrodes X and Y constituting each row electrode pair (X, Y) are each composed of bus electrodes Xa, Ya extending in a strip shape in the row direction, and transparent electrodes Xb, Yb that are lined up at regular intervals along the associated bus electrodes Xa, Ya. The transparent electrodes Xb and the transparent electrodes Yb each extend outward from their associated bus electrodes Xa and Ya toward their counterparts in the row electrode pair to confront each other with a discharge gap g in between.

A dielectric layer 2 is formed on the inner face of the front glass substrate 1 and covers the row electrode pairs (X, Y).

An MgO protective layer 3 is formed on the inner face of the dielectric layer 2 and covers the surface thereof.

The front glass substrate 1 is placed opposite the back glass substrate 4 with a discharge space in between. Address electrodes D are arranged in parallel at predetermined intervals in the row direction on the inner face (i.e. the face facing toward the display surface) of the back glass substrate 4. Each of the address electrodes D extends in the column direction at right angles to the row electrode pairs (X, Y) along the area opposite to paired transparent electrodes Xb and Yb of the row electrode pairs (X, Y).

A white column-electrode protective layer (dielectric layer) 5 is provided on the inner face of the back glass substrate 4 and covers the address electrodes D.

In turn, a partition wall unit 6 is formed on the column-electrode protective layer 5. The partition wall unit 6 is formed in an approximate grid shape made up of transverse walls 6A and vertical walls (not shown). The transverse walls 6A each extend in the row direction in an area opposite to the bus electrodes Xa, Ya and are arranged in the column direction. The vertical walls (not shown) each extend in the column direction approximately opposite to the mid-area between adjacent address electrodes D regularly arranged in the column direction and are arranged in the row direction. The partition wall unit 6 partitions the discharge space into areas in matrix form each corresponding to the opposing transparent electrodes Xb and Yb across the discharge gap g in each row electrode pair (X, Y) to form discharge cells C.

In the discharge cells C, phosphor layers 7 to which red, green and blue colors are applied are provided in such a manner as to be arranged in this color order in the row direction (FIG. 1 shows only the blue phosphor layer out of the red, green and blue phosphor layers). Each of the phosphor layers covers five faces in each discharge cell C: the side faces of the transverse walls 6A and the vertical walls of the partition wall unit 6 and the face of the portion of the column-electrode protective layer 5 defined by these transverse walls 6A and vertical walls.

The discharge space between the first and second glass substrates 1 and 4 is filled with a discharge gas including xenon (Xe).

The blue phosphor layer out of the phosphor layers 7 is formed of a coating material made by mixing a first phosphor 7a and a second phosphor 7b described in detail as follows.

The materials used for the first phosphor 7a, for example, an Eu activated silicate phosphor material such as (Ca, Mg) Si₂O₆:Eu, have a high resistance to a Xe resonance line (147 nm) and have the properties of absorbing ultraviolet light in a long-wavelength range (210 nm to 400 nm) and the Xe resonance line to thereby emit visible light, but permitting the passage of the Xe molecular beam (172 nm) with very little absorption.

Materials used for the second phosphor 7b have a high resistance to the Xe resonance line (147 nm) and the Xe molecular beam (172 nm) and have the properties of completely absorbing both the Xe resonance line and the Xe molecular beam and converting them into ultraviolet light (210 nm to 400 nm) in a longer wavelength range than the Xe resonance line and the Xe molecular beam. Examples of such materials include: a gadolinium, praseodymium coactivated phosphor material, such as gadolinium or praseodymium coactivated fluoride phosphor material (Y, Gd, Pr)F₃; a praseodymium activated phosphor material, such as praseodymium activated alumina borate phosphor material (Y, Pr)Al₃(BO₃)₄, praseodymium activated fluoride phosphor material (Y, Pr) F₃; a gadolinium activated phosphor material, such as gadolinium activated alumina borate phosphor material (Y, Gd)Al₃(BO₃)₄, gadolinium activated fluoride phosphor material (Y, Gd)F₃.

In the PDP thus structured, an address discharge is initiated selectively between the column electrode D and the transparent electrode Yb of the row electrode Y, and then a sustaining discharge is initiated between the row electrodes X and Y of the row electrode pair (X, Y) in each discharge cell (light-emitting cell) C having the deposition of wall charge on the dielectric layer 2 as a result of the address discharge. As a result of the sustaining discharge, vacuum ultraviolet light is generated from the xenon (Xe) in the discharge gas.

The phosphor layers 7 are excited by the vacuum ultraviolet light and thus emit visible light to generate an image in accordance with the video signal over the panel surface.

In this connection, in the case when the phosphor layer 7 is formed of the first phosphor 7a alone, the phosphor layer 7 has a high resistance to the Xe resonance line (147 nm) and the Xe molecular beam (172 nm) that are included in the vacuum ultraviolet light generated from the xenon (Xe) in the discharge gas. For this reason, the phosphor layer 7 is capable of adequately preventing deterioration over time. However, the first phosphor 7a allows the passage of the Xe molecular beam in the vacuum ultraviolet light and emits light by being excited by the Xe resonance line alone. Accordingly, this results in insufficient light-emission intensity.

FIG. 2 is a graph showing the excitation characteristic (absorption characteristics) when the first phosphor 7a is (Ca, Mg)Si₂O₆:Eu.

As shown in FIG. 2, the first phosphor 7a hardly absorbs the Xe molecular beam in 172 nm wavelength and therefore hardly emits light through the action of the Xe molecular beam.

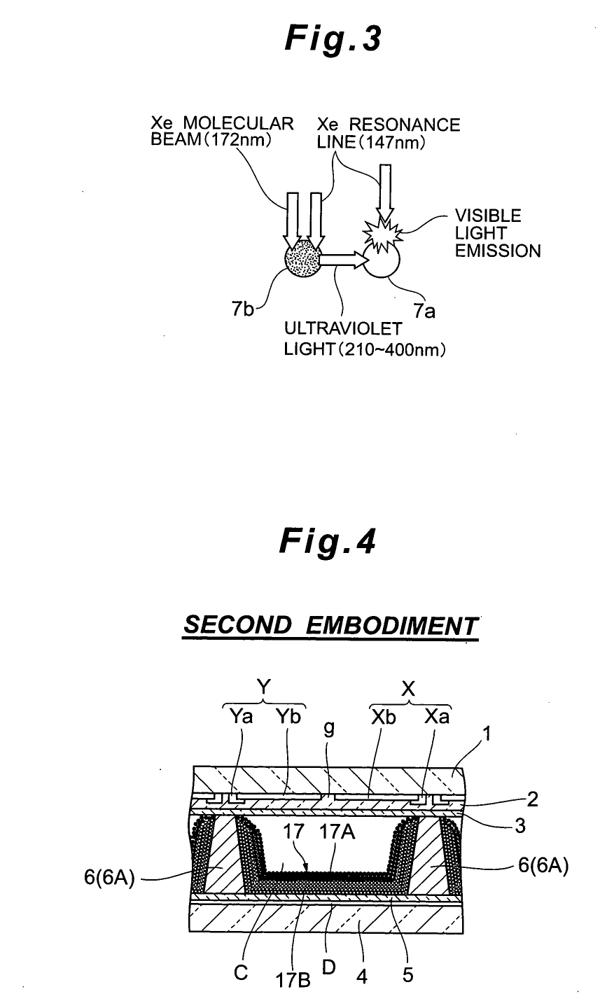

However, the PDP has the phosphor layers 7 formed by mixing the first phosphor 7a and the second phosphor 7b that has a high resistance to the Xe resonance line (147 nm) and the Xe molecular beam (172 nm). Accordingly, as shown in FIG. 3, the second phosphor 7b absorbs both the Xe resonance line and the Xe molecular beam in the vacuum ultraviolet light and converts the Xe resonance line and the Xe molecular beam into ultraviolet light in a long wavelength range (210 nm to 400 nm).

Thus, the first phosphor 7a emits light by being excited by the Xe resonance (147 nm) in the vacuum ultraviolet light and further emits light through the action of the ultraviolet light generated from the second phosphor 7b.

In this manner, the second phosphor 7b converting the molecular beam which has passed through the first phosphor 7a and the Xe resonance line directly radiated to the second phosphor 7b into ultraviolet light in a longer wavelength range than those of the Xe molecular beam and the Xe resonance line is mixed with the blue phosphor (first phosphor 7a) having a high resistance to the Xe resonance line (147 nm) and the Xe molecular beam (172 nm) in vacuum ultraviolet light but having a low light-emission intensity because the Xe molecular beam passes therethrough, to form the phosphor layers 7. Thus, the PDP comes to have the blue phosphor layers 7 having a high resistance to vacuum ultraviolet light and high light-emission intensity.

Further, the PDP is capable of decreasing the conversion loss as compared with that in the conventional PDPs, because the first phosphor 7a forming part of the blue phosphor layer 7 emits light through excitation by the Xe resonance, and the second phosphor 7b converts the Xe molecular beam which has not contributed to the light emission from the first phosphor 7a into ultraviolet light to contribute to the light emission.

### Second Embodiment

FIG. 4 is a sectional view illustrating a second embodiment when the gas-discharge display apparatus according to the present invention is used for a PDP.

FIG. 4 shows the section of the structure of an area of the PDP surrounding a discharge cell taken in the column direction. The first and second embodiments are the same except for the structure of the phosphor layer. The same structural components are designated by the same reference numerals.

The PDP in the second embodiment includes blue phosphor layers 17 each covering five faces in the discharge cell C: the side faces of the transverse walls 6A and the vertical walls of the partition wall unit 6 and the face of the portion of the column-electrode protective layer 5 surrounded by the transverse walls 6A and the vertical walls. Each of the blue phosphor layers 17 is constituted in a double layer structure consisting of a first phosphor layer 17A and a second phosphor layer 17B with its inner face covered by the first phosphor layer 17A, which are formed of materials as described later.

The materials used for the first phosphor layer 17A, for example, an Eu activated silicate phosphor material such as (Ca, Mg)Si₂O₆:Eu, have a high resistance to the Xe resonance line (147 nm) and the properties of absorbing the Xe resonance line and ultraviolet light in a long wavelength range (210 nm to 400 nm) and thereby emitting light, but allowing the Xe molecular beam (172 nm) to pass through with very little absorption.

The materials used for the second phosphor layer 17B have a high resistance to the Xe resonance line (147 nm) and the Xe molecular beam (172 nm) and have the properties of completely absorbing both the Xe resonance line and the Xe molecular beam and converting them into ultraviolet light (210 nm to 400 nm) in a longer wavelength range than the Xe resonance line and the Xe molecular beam. Examples of such materials include: a gadolinium, praseodymium coactivated phosphor material, such as gadolinium or praseodymium coactivated fluoride phosphor material (Y, Gd, Pr) F₃; a praseodymium activated phosphor material, such as praseodymium activated alumina borate phosphor material (Y, Pr)Al₃(BO₃)₄, praseodymium activated fluoride phosphor material (Y, Pr) F₃; a gadolinium activated phosphor material, such as gadolinium activated alumina borate phosphor material (Y, Gd)Al₃(BO₃)₄, gadolinium activated fluoride phosphor material (Y, Gd)F₃.

For this phosphor layer 17, the second phosphor layer 17B is first formed in such a manner as to cover the five faces in the discharge cell C: the side faces of the transverse walls 6A and the vertical walls of the partition wall unit 6 and the face of the portion of the column-electrode protective layer 5 surrounded by the transverse walls 6A and the vertical walls. Next, the first phosphor layer 17A is laminated onto the second phosphor layer 17B.

The first phosphor layer 17A and the second phosphor layer 17B are formed of coating materials including phosphor powder having the foregoing material properties by a method such as screen-printing or nozzle coating. In this case, as the phosphor powder included in the coating materials for forming the second phosphor layer 17B which is the bottom layer, a flat-grained powder, rather than a round-grained powder is preferably used in order to prevent the phosphor powder from causing a diffuse reflection of the Xe molecular beam (172 nm) which has traveled through the first phosphor layer 17A.

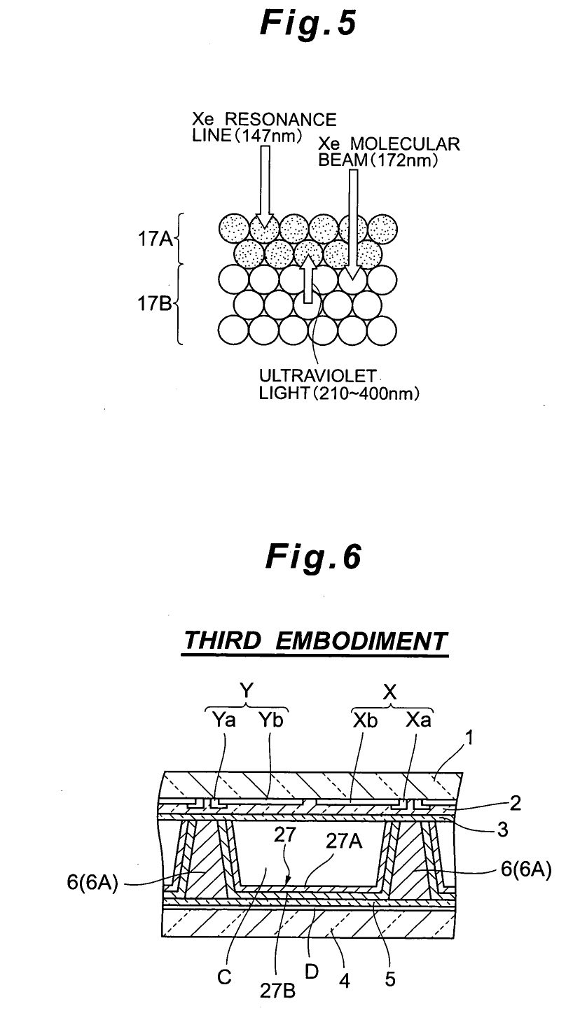

In a PDP having the phosphor layers 17 of the foregoing double-layer structure, when a discharge is initiated between the transparent electrodes Xb and Yb facing each other across the discharge gap g in the row electrode pair (X, Y), as shown in FIG. 5, the Xe resonance line (147 nm) in the vacuum ultraviolet light generated from the xenon (Xe) included in the discharge gas filling the discharge cell C is absorbed by the first phosphor layer 17A and excites the first phosphor layer 17A to enable it to emit visible light.

The Xe molecular beam (172 nm) in the vacuum ultraviolet light passes through the first phosphor layer 17A and does not contribute to the light emission from the first phosphor layer 17A. The Xe molecular beam, however, is absorbed by the second phosphor layer 17B lying beneath the first phosphor layer 17A and is converted by the second phosphor layer 17B into ultraviolet light in a longer wavelength range (210 nm to 400 nm) than those of the Xe resonance line and the Xe molecular beam.

Then, the ultraviolet light in a longer wavelength range (210 nm to 400 nm) than those of the Xe resonance line and the Xe molecular beam produced by the action of the second phosphor layer 17B enables the first phosphor layer 17A to emit visible light.

As described hitherto, a first phosphor layer 17A formed of blue phosphor having a high resistance to the Xe resonance line (147 nm) and the Xe molecular beam (172 nm) in the vacuum ultraviolet light but being low in light-emission intensity by reason of allowing the Xe molecular beam to pass through is deposited on a second phosphor layer 17B converting the Xe molecular beam having passed through the first phosphor layer 17A into ultraviolet light of a longer wavelength than those of the Xe resonance line and the Xe molecular beam. Thereby, the PDP comes to have the blue phosphor layers 17 having a high resistance to vacuum ultraviolet light and high light-emission intensity.

Further, the PDP is capable of decreasing the conversion loss as compared with that in the conventional PDPs, because most of the Xe resonance line in the vacuum ultraviolet light contributes to light emission from the first phosphor layer 17A that forms part of the blue phosphor layer 17, and the second phosphor layer 17B contributes to light emission through the conversion of only the Xe molecular beam which has passed through the first phosphor layer 17A into ultraviolet light.

### Third Embodiment

FIG. 6 is a sectional view illustrating a third embodiment when the gas-discharge display apparatus according to the present invention is used for a PDP.

FIG. 6 shows the section of the structure of an area of the PDP surrounding a discharge cell taken in the column direction. The first and third embodiments are the same except for the structure of the phosphor layer. The same structural components are designated by the same reference numerals.

In FIG. 6, in each discharge cell C, a phosphor layer 27 covers the five faces: the side faces of the transverse walls 6A and the vertical walls of the partition wall unit 6 and the face of the portion of the column-electrode protective layer 5 surrounded by the transverse walls 6A and the vertical walls. Each of the blue phosphor layers 27 is constituted in a double-layer structure consisting of a first blue phosphor layer 27A formed of materials described later and a second phosphor layer 27B with its inner face covered by the first phosphor layer 27A.

The material used for the first phosphor layer 27A, for example, an Eu activated silicate phosphor material such as (Ca, Mg)Si₂O₆:Eu, have a high resistance to the Xe resonance line (147 nm) and have the properties of absorbing the Xe resonance line and ultraviolet light in a long wavelength range (210 nm to 400 nm) and thereby emitting light, but allowing the Xe molecular beam (172 nm) to pass through with very little absorption.

The materials used for the second phosphor layer 27B have a high resistance to the Xe resonance line (147 nm) and the Xe molecular beam (172 nm) and have the properties of completely absorbing both the Xe resonance line and the Xe molecular beam and generating ultraviolet light in a longer wavelength range (210 nm to 400 nm) than the Xe resonance line and the Xe molecular beam. Examples of such materials include: a gadolinium, praseodymium coactivated phosphor material, such as gadolinium or praseodymium coactivated fluoride phosphor material (Y, Gd, Pr)F₃; a praseodymium activated phosphor material, such as praseodymium activated alumina borate phosphor material (Y, Pr)Al₃(BO₃)₄, praseodymium activated fluoride phosphor material (Y, Pr) F₃; a gadolinium activated phosphor material, such as gadolinium activated alumina borate phosphor material (Y, Gd)Al₃(BO₃)₄, gadolinium activated fluoride phosphor material (Y, Gd)F₃.

In the first phosphor layer 27A and the second phosphor layer 27B of the phosphor layer 27, at least the second phosphor layer 27B which is the bottom layer is formed in a transparent thin film form by thin-film forming techniques, such as a CVD technique, an electron-beam evaporation technique, a sputtering technique, for example.

The first phosphor layer 27A which is the top layer may be formed in transparent thin film form as in the case of the second phosphor layer 27B, or alternatively may be formed by a method such as screen-printing or nozzle coating, using coating materials including a powder phosphor materials, as in the case of the second embodiment.

As in the case of the second embodiment, to form the phosphor layer 27, the second phosphor layer 27B is first formed in such a manner as to cover the five faces in the discharge cell C: the side faces of the transverse walls 6A and the vertical walls of the partition wall unit 6 and the face of the portion of the column-electrode protective layer 5 surrounded by the transverse walls 6A and the vertical walls. Next, the first phosphor layer 27A is laminated onto the second phosphor layer 27B.

In a PDP having the phosphor layers 27 of the foregoing double-layer structure, when a discharge is initiated between the transparent electrodes Xb and Yb facing each other across the discharge gap g in the row electrode pair (X, Y), the Xe resonance line (147 nm) in the vacuum ultraviolet light generated from the xenon (Xe) included in the discharge gas filling the discharge cell C is absorbed by the first phosphor layer 27A and excites the first phosphor layer 27A to enable it to emit visible light.

The Xe molecular beam (172 nm) in the vacuum ultraviolet light passes through the first phosphor layer 27A and does not contribute to the light emission from the first phosphor layer 27A. The Xe molecular beam, however, is absorbed by the second phosphor layer 27B lying beneath the first phosphor layer 27A and is converted by the second phosphor layer 27B into ultraviolet light in a longer wavelength range (210 nm to 400 nm) than those of the Xe resonance line and the Xe molecular beam.

Then, the ultraviolet light in a longer wavelength range (210 nm to 400 nm) than those of the Xe resonance line and the Xe molecular beam by the second phosphor layer 27B enables the first phosphor layer 27A to further emit visible light.

As described hitherto, a first phosphor layer 27A, which is formed of blue phosphor having a high resistance to the Xe resonance line (147 nm) and the Xe molecular beam (172 nm) in the vacuum ultraviolet light but being low in light-emission intensity by reason of allowing the Xe molecular beam to pass through, is deposited on a second phosphor layer 27B converting the Xe molecular beam having passed through the first phosphor layer 27A into ultraviolet light of a longer wavelength than those of the Xe resonance line and the Xe molecular beam. Thereby, the PDP comes to have the blue phosphor layers 27 having a high resistance to vacuum ultraviolet light and high light-emission intensity.

Further, the PDP is capable of decreasing the conversion loss as compared with that in the conventional PDPs, because most of the Xe resonance line in the vacuum ultraviolet light contributes to light emission from the first phosphor layer 27A that forms part of the blue phosphor layer 27, and the second phosphor layer 27B contributes to light emission through the conversion of only the Xe molecular beam which has passed through the first phosphor layer 27A into ultraviolet light.

Further, the PDP according to the third embodiment is capable of emitting light at high intensity because the second phosphor layer 27A is formed in a transparent thin film form to thereby reduce the diffuse reflection of the Xe molecular beam caused by the second phosphor layer 27A.

The terms and description used herein are set forth by way of illustration only and are not meant as limitations. Those skilled in the art will recognize that numerous variations are possible within the spirit and scope of the invention as defined in the following claims.

What is claimed is:

1. A gas-discharge display apparatus having a pair of opposing substrates which are placed on either side of a discharge space and between which phosphor layers are provided and discharge producing members are provided for initiating a discharge within the discharge space, the discharge space being filled with a discharge gas that includes xenon and generates vacuum ultraviolet light including a xenon molecular beam and a xenon resonance line by means of the discharge initiated between the discharge producing members, comprising
phosphor layers emitting visible light by being excited by the vacuum ultraviolet light generated from the discharge gas, each of the phosphor layers including:
a first phosphor that has a resistance to the xenon resonance line, absorbs the xenon resonance line and ultraviolet light in a longer wavelength range than those in the xenon resonance line and the xenon molecular beam and allows the xenon molecular beam to pass through; and
a second phosphor that absorbs the xenon resonance line and the xenon molecular beam and generates ultraviolet light in a longer wavelength range than those in the xenon resonance line and the xenon molecular beam.

2. A gas-discharge display apparatus according to claim 1, wherein the first phosphor is an europium activated silicate phosphor material.

3. A gas-discharge display apparatus according to claim 1, wherein the second phosphor is any one selected from the group consisting of a gadolinium activated phosphor material, a praseodymium activated phosphor material and a gadolinium, praseodymium coactivated phosphor material.

4. A gas-discharge display apparatus according to claim 3, wherein the second phosphor includes a flat-grained phosphor powder.

5. A gas-discharge display apparatus according to claim 1, wherein the phosphor layer is formed of a mixture of the first phosphor in powder form and the second phosphor in powder form.

6. A gas-discharge display apparatus according to claim 1, wherein the phosphor layer is formed in a double layer structure consisting of a first phosphor layer including the first phosphor and a second phosphor layer including the second phosphor and having its surface covered by the first phosphor layer.

7. A gas-discharge display apparatus according to claim 6, wherein at least the second phosphor layer in the phosphor layer is formed of a transparent phosphor thin-film.

8. A gas-discharge display apparatus according to claim 1, wherein the gas-discharge display apparatus is a plasma display panel, and the phosphor layers each having the first phosphor and the second phosphor are phosphor layers having three primary colors and respectively formed in unit light emitting areas arranged in matrix form within the discharge space.
